(19) United States
(12) Patent Application Publication
(10) Pub. No.: US 2015/0093246 A1
(43) Pub. Date: Apr. 2, 2015

(54) BLADE PITCH CONTROLLER FOR SMALL-SCALE WIND POWER GENERATION SYSTEM

(71) Applicant: GU CO., LTD., Hwaseong-si (KR)

(72) Inventor: Jong Rai LEE, Hwaseong-si (KR)

(73) Assignee: GU CO., LTD., Hwaseong-si (KR)

(21) Appl. No.: 14/135,594

(22) Filed: Dec. 20, 2013

(30) Foreign Application Priority Data
Sep. 30, 2013 (KR) 10-2013-0115993

(51) Int. Cl. F03D 7/02

(52) U.S. Cl. CPC F03D 7/0224
USPC 416/147

(57) ABSTRACT

Disclosed is a blade pitch controller for a small-scale wind power generation system. Movable segments are integrally formed on an outer circumferential surface of the movable block, have moving grooves, and move backward and forward along with the movable block. Pitch adjustment pieces have adjustment pins formed at one end of each thereof, key grooves into which blade shafts are fixedly inserted are formed in the middles thereof, and pitch angles of blades are changed by angles changed when the movable block moves backward and forward. Pitch adjustment cylinders are coupled to fixing pieces formed at one end of each of the pitch adjustment pieces by hinges so as to be able to be located near the adjustment pins, are compressed when the movable block moves backward, and cause the pitch adjustment pieces to return to an original state after being compressed.

### BACKGROUND OF THE INVENTION

1. Field of the Invention

The present invention relates, in general, to a blade pitch controller for a small-scale wind power generation system, and, more particularly, to a blade pitch controller for a small-scale wind power generation system in which a blade pitch is automatically controlled using a pitch adjustment piece and a pitch adjustment cylinder, thereby continuously maintaining a necessary rotating force of blades to be able to perform continuous power generation.

2. Description of the Related Art

In the case of wind power generation, the kinetic energy of wind is converted into mechanical energy by a turbine, and then the mechanical energy is converted into electrical energy. In this case, the kinetic energy of wind is generally converted into an amount of energy which is proportional to a value obtained by multiplying the cube of a wind speed by an area of a turbine. A wind power generation system is classified as a horizontal axis type and a vertical axis type according to the direction of a rotary shaft. The horizontal axis type wind power generation system (called a propeller type wind power generation system) is mainly used at present.

In the horizontal axis type wind power generation system, when a strong wind exceeding a rated wind speed blows, the strong wind has a serious effect on a mechanical structure due to overheating or excessive rotation. To avoid this, when a strong wind blows, various types of excessive wind speed controllers which cause a rotor and a nacelle to deviate from the wind direction or reduce the rotating speed of rotor blades are used.

A large-scale wind power generation system electrically causes a rotor and a nacelle to deviate from the wind direction using a signal from an anemometer, or controls a rotor blade pitch to reduce a rotating force of the rotor blades.

The small-scale wind power generation system causes a rotor and a nacelle to deviate from a wind direction using a tail wing. In other words, directions of rotor blades are aerodynamically made perpendicular to the wind direction using a simple configuration in which a rear wing is fixedly installed at a rear end of a shaft of the rotor blades. However, in this system, whenever the rotor and the nacelle are caused to deviate from the wind direction and then return to their original positions, continuous vibration is applied to the tail wing. As such, the system or a hinge mechanism may be damaged.

A pitch control method mainly uses a method in which the directions of the rotor blades are controlled to be inclined with respect to the wind direction using a detection signal provided from a wind direction/speed detector configured to detect the wind direction and the wind speed. However, such a method is mainly applied to a large-scale wind power generation system, but it is not applied to a small-scale wind power generation system due to a cost and installation limitation of a controller.

On the other hand, a method of controlling the output of the wind power generation system is classified into a control method of the wind power generation system and a control method of indirectly supporting the output of the wind power generation system using a shape of the blade.

The latter, i.e. the method of restricting a blade rotating speed using aerodynamic characteristics of the rotor blades is classified into a stall control technique and a pitch control technique. According to the present invention, the pitch control technique which is a method of adjusting a blade (vane) angle to reduce lift applied to the blades and adjusting torque is applied to the small-scale wind power generation system.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korean Patent No. 10-1043430 (system for controlling pitch angle of wind turbine);

(Patent Document 2) Korean Patent No. 10-1110908 (wind turbine generator and method of controlling the same);

### SUMMARY OF THE INVENTION

Accordingly, the present invention has been made keeping in mind the above problems occurring in the related art, and the present invention is intended to propose a blade pitch controller for a small-scale wind power generation system in which a blade pitch is automatically controlled using a pitch adjustment piece and a pitch adjustment cylinder, thereby continuously maintaining a necessary rotating force of blades to be able to perform continuous power generation.

In order to achieve the above object, according to one aspect of the present invention, there is provided a blade pitch controller for a small-scale wind power generation system, which includes: a plurality of movable segments that are integrally formed on an outer circumferential surface of the movable block, have moving grooves formed in outer circumferential surfaces thereof, and move backward and forward along with the movable block; pitch adjustment pieces in which adjustment pins inserted into the moving grooves are formed at one end of each thereof, key grooves into which blade shafts are fixedly inserted are formed in the middles thereof, and pitch angles of blades are changed by angles changed when the movable block moves backward and forward; and pitch adjustment cylinders that are coupled to fixing pieces formed at one end of each of the pitch adjustment pieces by hinges so as to be able to be located near the adjustment pins, are compressed when the movable block moves backward, and cause the pitch adjustment pieces to return to an original state after being compressed

Here, each of the pitch adjustment cylinders may include: a rod having one end of which is coupled to the fixing piece by the hinge and the other end of which is coupled to a compression plate; a cylinder body that houses the rod and is coupled to a bracket formed at an end of a housing by a hinge; and a spring which is compressed between the compression plate and the cylinder body when the movable block moves backward, and causes the pitch adjustment piece 200 to return to an original state using a spring force after being compressed.

Further, the pitch adjustment cylinders may be independently installed on the pitch adjustment pieces.

As described above, according to the present invention, since the blade pitch is automatically controlled using the pitch adjustment piece and the pitch adjustment cylinder, a necessary rotating force of the blades can be continuously maintained, and thus continuous power generation can be performed.

In addition, since the small-scale wind power generation system according to the present invention automatically adjusts the pitch angle by rotation of the blades according to a rated speed, even when a wind speed is equal to or more than the rated speed, electric power can normally be output.

In addition, the pitch angles of the blades are automatically adjusted at an excessive wind speed. Therefore, since components are not damaged due to the excessive wind speed, stability of the small-scale wind power generation system can be ensured.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a configuration view showing an entire connection of a blade pitch controller according to the present invention;

FIG. 2 is a configuration view showing a connection of a pitch adjustment cylinder and a pitch adjustment piece according to the present invention;

FIG. 3 is a configuration view showing a state in which a spring of the pitch adjustment cylinder according to the present invention is not compressed; and

FIG. 4 is a configuration view showing a state in which the spring of the pitch adjustment cylinder according to the present invention is compressed.

### DETAILED DESCRIPTION OF THE INVENTION

Hereinbelow, an exemplary embodiment of the present invention will be described in more detail with reference to the accompanying drawings.

A small-scale wind power generation system according to and embodiment of the present invention includes a pitch control converter that detects whether or not a rotating speed of blades 400 exceeds a reference rotating speed due to an excessive wind speed while monitoring the rotating speed of the blades 400 in real time, an inverter that converts electrical energy generated by rotation of the blades into an available current, and an electric generator that generates electricity while rotating in the same direction and rotating speed as the rotating blades, and a movable block that moves backward and forward under the control of the pitch control converter. This configuration is identical to that of the related art. The pitch control converter, the inverter, and the electric generator are not shown in the drawings.

To be specific, the pitch control converter converts a frequency of a current generated by rotation of the electric generator into revolutions per minute (rpm), and monitors the rpm to control a pitch angle of the blade 400. The pitch control converter functions to operate the small-scale wind power generation system.

For example, when a rated speed of the blades is 100 rpm, the blades operate normally at 100 rpm without pitch control. When the rotating speed of the blades exceeds a reference rotating speed of 110 rpm due to an excessive wind speed, the pitch angle is adjusted to a first pitch angle under the control of the pitch control converter. Then, the pitch control converter monitors a current rotating speed of the blades in real time. In this process, when the current rotating speed of the blades is equal to or more than the reference rotating speed of 110 rpm, the first pitch angle is adjusted to a second pitch angle again. When the rotating speed of the blades is equal to or less than the reference rotating speed, the first pitch angle is continuously maintained until the rotating speed is reduced to a minimum rpm (for example, 80 rpm) or less. When the wind speed is gradually reduced to the minimum rpm or less, the first pitch angle is caused to return to an original state.

When the wind speed increases at the second pitch angle and thus the rotating speed exceeds the reference rotating speed of 110 rpm, the second pitch angle is adjusted to a third pitch angle. When the rotating speed exceeds the reference rotating speed set in this way, the pitch angle is adjusted to control the rotating speed step by step. In addition, when the wind speed decreases and thus the rotating speed is reduced, the pitch angle returns to the previous state. When the pitch angle returns to the previous state, the rotating speed is monitored for a predetermined time, and thereby the pitch angle is controlled. The variable pitch angles may be controlled in units of 1° or 2°. Finally, the pitch angle is controlled to an angle of 90° so as to be parallel to the wind direction. As the wind passes without colliding with the blades, the rotating speed can be adjusted to about 0 (zero).

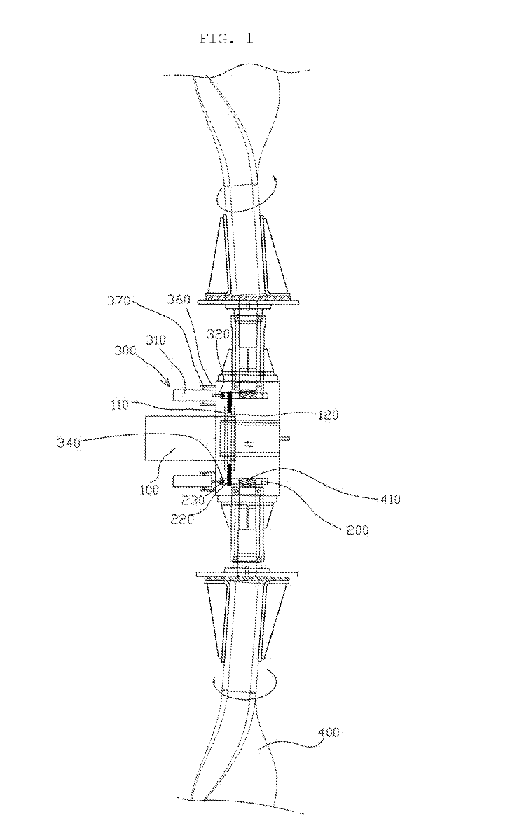

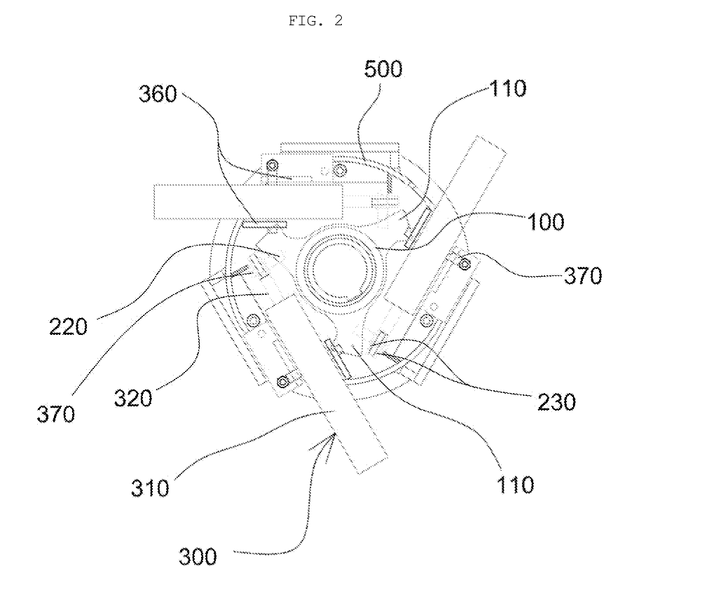

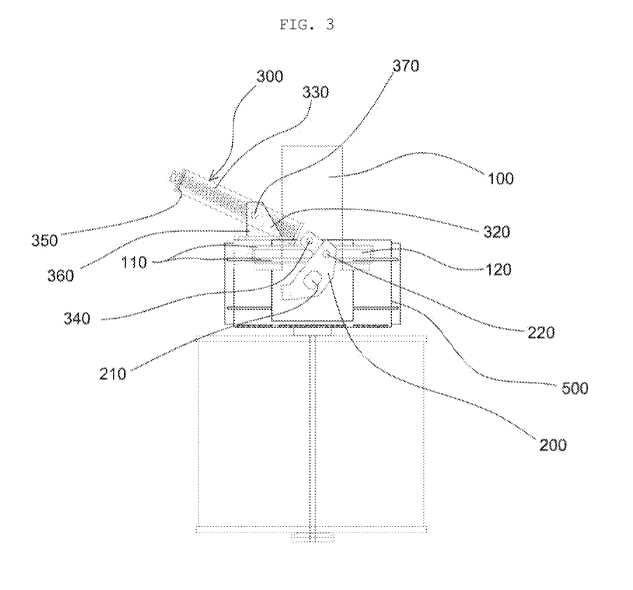

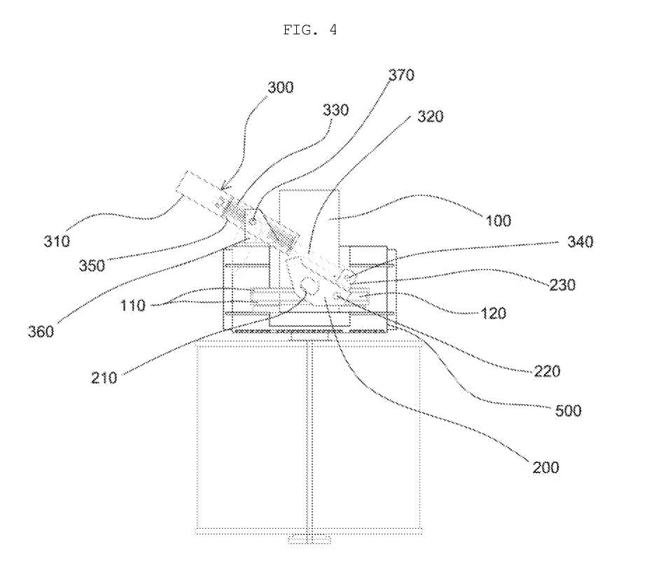

The blade pitch controller of the present invention is configured so that the pitch angle of the blade is more easily adjusted using such components. As shown in FIGS. 1 to 4, the blade pitch controller further includes a plurality of movable segments 110 that are integrally formed on an outer circumferential surface of the movable block 100, have moving grooves 120 formed in outer circumferential surfaces thereof, and move backward and forward along with the movable block 100, pitch adjustment pieces 200 in which adjustment pins 220 inserted into the respective moving grooves 120 are formed at one end of each thereof, key grooves 210 into which blade shafts 410 are fixedly inserted are formed in the middles thereof, and the pitch angles of the blades 400 are changed by angles changed when the movable block 100 moves backward and forward, and pitch adjustment cylinders 300 that are coupled to fixing pieces 230 formed at one end of each of the pitch adjustment pieces 200 by hinges 340 so as to be able to be located near the adjustment pins 220, are compressed when the movable block 100 moves backward, and cause the pitch adjustment pieces 200 to return to an original state after being compressed.

Each pitch adjustment cylinder 300 includes a rod 320, one end of which is coupled to the fixing piece 230 by the hinge 340 and the other end of which is coupled to a compression plate 350, a cylinder body 310 that houses the rod 320 and is coupled to a bracket 360 formed at an end of a housing 500 by a hinge 370, and a spring 330 which is compressed between the compression plate 350 and the cylinder body 310 when the movable block 100 moves backward, and causes the pitch adjustment piece 200 to return to an original state using a spring force after being compressed.

In the pitch adjustment cylinder as described above, the cylinder body is coupled to the bracket by the hinge, and the rod is coupled to the fixing piece by the hinge. As such, the rod is smoothly translated in the cylinder when the movable block moves backward and forward.

Since the movable segments have three blades, the movable segments are formed in a triangular star shape, and the pitch adjustment pieces are installed on the movable segments, respectively. The pitch adjustment cylinders are installed on the pitch adjustment pieces, respectively.

According to the present invention configured in this way, when the rated speed of the blades is assumed to be 100 rpm, the small-scale wind power generation system is normally operated at 100 rpm without a separate pitch control.

The blades 400 of the small-scale wind power generation system that is in normal operation rotate normally. The frequency of the current generated by the electric generator is converted into the rpm by the pitch control converter, and the rpm is monitored by the pitch control converter. Thereby, the rotating speed of the blades is monitored in real time.

When the rotating speed of the blades exceeds the reference rotating speed of 110 rpm due to an excessive wind speed, the pitch angle of the small-scale wind power generation system is adjusted to the first pitch angle under the control of the pitch control converter.

In other words, when the pitch angle is adjusted to the first pitch angle, the movable segments 110 formed integrally with the movable block 100 move backward together, and the adjustment pins 220 inserted into the moving grooves 120 of the movable segments 110 move along the movable segments 110. In this case, the angles of the pitch adjustment pieces 200 are changed, and the pitch angles of the blades 400 are changed by the blade shafts 410 coupled to the key grooves 210 of the pitch adjustment pieces 200 whose angles are changed. Meanwhile, the rods 320 coupled to the fixing pieces 230 by the hinges 230 compress the springs 330 while being pulled out of the cylinder bodies 310.

In this state, when the rotating speed of the blades is reduced to be less than the reference rotating speed, the movable block 100 moves forward opposite the foregoing. In this case, the rod 320 returns the pitch adjustment piece to its original state while the rod 320 is pushed into the cylinder body 310 by the spring force of the spring 330 that has been compressed. In this process, the pitch angle of the blade is adjusted.

According to the present invention as described above, when the rotating speed of the blades exceeds the reference rotating speed of 110 rpm due to an excessive wind speed, the pitch angle of the blade is sequentially adjusted to the first, second, or third pitch angle. In contrast, when the rotating speed of the blades is reduced to be less than the reference rotating speed, the pitch angle of the blade is sequentially adjusted to the third, second, or first pitch angle.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A blade pitch controller for a small-scale wind power generation system, comprising:
a plurality of movable segments that are integrally formed on an outer circumferential surface of the movable block, have moving grooves formed in outer circumferential surfaces thereof, and move backward and forward along with the movable block;
pitch adjustment pieces in which adjustment pins inserted into the moving grooves are formed at one end of each thereof, key grooves into which blade shafts are fixedly inserted are formed in the middles thereof, and pitch angles of blades are changed by angles changed when the movable block moves backward and forward; and
pitch adjustment cylinders that are coupled to fixing pieces formed at one end of each of the pitch adjustment pieces by hinges so as to be able to be located near the adjustment pins, are compressed when the movable block moves backward, and cause the pitch adjustment pieces to return to an original state after being compressed.

2. The controller of claim 1, wherein each of the pitch adjustment cylinders includes
a rod having one end of which is coupled to the fixing piece by the hinge and the other end of which is coupled to a compression plate, a cylinder body that houses the rod and is coupled to a bracket formed at an end of a housing by a hinge, and a spring which is compressed between the compression plate and the cylinder body when the movable block moves backward, and causes the pitch adjustment piece 200 to return to an original state using a spring force after being compressed.

3. The controller of claim 1, wherein the pitch adjustment cylinders are independently installed on the pitch adjustment pieces.
